(19) United States
(12) Patent Application Publication
(10) Pub. No.: US 2021/0352918 A1
(43) Pub. Date: Nov. 18, 2021

(54) DEVICE FOR STAMPING DOUGH PIECES

(71) Applicant: FRITSCH BAKERY TECHNOLOGIES GMBH & CO. KG, Markt Einersheim (DE)

(72) Inventor: Udo BERNHARDT, Iphofen (DE)

(73) Assignee: FRITSCH BAKERY TECHNOLOGIES GMBH & CO. KG, Markt Einersheim (DE)

(21) Appl. No.: 17/282,485

(22) PCT Filed: Jul. 15, 2019
(86) PCT No.: PCT/EP2019/069014

§ 371 Date: Apr. 2, 2021

(30) Foreign Application Priority Data
Oct. 2, 2018 (DE) 102018124350.2

(51) Int. Cl. A21C 11/02; A21C 11/12; A21C 9/08

(52) U.S. Cl. CPC A21C 11/02; A21C 9/08; A21C 11/12

(57) ABSTRACT

The present disclosure relates to a device for embossing, imprinting, cutting or stamping dough pieces, and the device includes a positioning unit and a tool. The tool includes at least one stamp adapted to be brought into engagement with a dough piece. When the dough pieces are arranged in an undefined position on a flat support, the positioning unit is capable of detecting at least a position of one dough piece, and the tool is adapted to be centered at a target position above the one dough piece.

### CROSS-REFERENCE TO RELATED APPLICATIONS

This application is the U.S. national phase of PCT Application No. PCT/EP2019/069014 filed on Jul. 15, 2019, which claims priority to German Patent Application No. DE 10 2018 124 350.2 filed on Oct. 2, 2018, the disclosures of which are incorporated in their entireties by reference herein.

### TECHNICAL FIELD

The present disclosure relates to a device for embossing, imprinting, cutting or stamping dough pieces with a positioning unit and a tool, and to a method of embossing, imprinting, cutting or stamping dough pieces.

### BACKGROUND

The prior art discloses various devices and methods for decorating dough pieces by embossing, imprinting, cutting and stamping. Stamping is understood by those skilled in the art such that patterns are impressed into or cut into a dough piece with a blunt or sharp stamp before baking. Within the scope of the present disclosure, the term “stamping” comprises embossing, imprinting and cutting of dough pieces. The change in form and shape of the dough piece in the course of stamping serves not only to decorate but also to influence the taste of the dough product. Following the stamping process, the shaped dough pieces are fed to the subsequent processes and baked into finished dough products.

According to a known embodiment, the stamping is carried out manually by bringing the tool, in particular a stamp, into engagement with the dough piece by hand. This, however, entails a high expenditure of time and costs as well as a high susceptibility to errors, which is why manual stamping is only suitable to a limited extent for mass production of dough products.

According to a further embodiment, it is known from the prior art to position a plurality of dough pieces simultaneously side-by-side on a support and to move the support in a predetermined cycle while the dough pieces are being stamped. The preparation process of stamping during the baking of dough products, in particular bread rolls, can be accelerated substantially by such devices.

A problem arising in connection with the above-mentioned solutions is, however, the precise orientation of the tool and the dough piece relative to each other, so that the dough piece can be stamped precisely at the center or at a predetermined target position. For mass production, however, it is necessary to produce the highest possible number of dough products of as identical a shape as possible within the shortest possible time. This necessitates short cycle times, which means that the precision of the devices used for stamping has to satisfy high demands.

For this purpose, it is known to use systems of the generic kind with pressure cups in combination with stamping tools for shaping dough pieces. The dough pieces are here transferred from an upstream fermentation process to a stamping station by placing the dough pieces in pressure cups of the stamping station. The pressure cups move on a conveyor belt and convey the dough pieces to a stamping unit, with a single dough piece in each pressure cup. The stamping unit brings the stamping tool into engagement with the dough piece, whereby a pattern predetermined by the tool, in particular by a stamp, is imparted to the dough piece. After stamping, the pressure cup moves together with the stamped dough piece to a conveyor belt continuing the conveyance, on which the dough piece is deposited and fed to the subsequent processes.

A problem arising in the case of the above-described prior art is that the dough pieces are not fully identical and do not always come to lie precisely at the center of the pressure cup. Due to the off-center position of the dough pieces in the pressure cup, the dough piece is not centrally stamped in the stamping unit and the finished dough product appears asymmetrical. This repeatedly results in reworking and/or rejects, since the dough piece has to be discarded in the following due to malformation.

In order to avoid these problems, also a system of the generic kind used for stamping dough pieces is known, in the case of which a dough piece in the pressure cup has applied thereto compressed air, so as to center the dough piece in the pressure cup. By aligning the dough piece in the pressure cup, the dough piece can be embossed or imprinted at the center. This solution is, however, disadvantageous insofar as it is still necessary to place the dough pieces in pressure cups, whereupon they are stamped, and can only then be fed to a conveyor belt conveying the dough pieces to the subsequent processes. However, for a continuous mass production of dough products, dough pieces are provided by kneading a flat dough sheet on a continuously driven conveyor belt. The stamping of the dough pieces in pressure cups, however, necessitates a clocked operation of the device for stamping and is therefore disadvantageous for continuous mass production. Furthermore, the above-mentioned solution of the generic kind has the disadvantage that the dough piece has compressed air applied thereto and that this may easily trigger an inhalative allergy to flour dust. In addition, it is disadvantageous that the sensitive dough piece is stressed by the application of compressed air on the one hand and the discharge from the pressure cup onto the conveyor belt on the other, which may lead to deformations and injuries of the dough piece.

It is therefore an object of the present disclosure to provide a device for embossing, imprinting, cutting or stamping a dough piece, which avoids the disadvantages of the known prior art.

### SUMMARY

The device according to the present disclosure is based on the basic concept of detecting the undefined position of dough pieces on a flat support and moving a tool to the dough pieces for the purpose of stamping. Within the framework of the present disclosure, it has been found essential to provide the device for embossing, imprinting, cutting or stamping a dough piece with a positioning unit, by means of which the position of a dough piece can be detected and a tool can be centered at a target position above the dough piece. In this way, the tool, which includes at least one stamp, can be oriented precisely above the dough piece and brought into engagement with the dough piece in such a way that identical patterns will be formed into each dough piece, thus producing identical dough products. Depending on the type of dough product and/or pattern, a blunt stamp may be used for impressing the pattern or a sharply ground stamp having essentially the function of a knife may be used for cutting-in a pattern. It has been found to be advantageous that, by orienting the tool according to the undefined position of the dough pieces, stamping will be possible without additional stress and, consequently, without a deformation of the dough pieces going beyond the stamping. Orienting the dough pieces on the support manually or mechanically or transferring the dough pieces to pressure cups will not be necessary, which, on the one hand, will considerably simplify process control and, on the other hand, prevent a deformation of the very sensitive dough pieces. In addition, it has been recognized in accordance with the present disclosure that the use of compressed air for positioning the dough pieces should be dispensed with, since compressed air in combination with flour leads to a more intense exposure to flour dust, which will increase the risk of triggering a flour dust allergy among the employees present in the exposure area of the plant.

According to a preferred embodiment, the target position, at which the tool is oriented above the dough piece, can be determined on the basis of the surface center of gravity or the geometric center of gravity. In this way, in particular the center of a round dough piece can be detected precisely and the stamp of the tool can be brought into engagement with the dough piece at a corresponding position. Advantageously, it is, however, also possible to use the surface center of gravity or the geometric center of gravity for positioning the stamp above dough pieces that are not round in shape, e.g., dough pieces that are elongate in shape. This is particularly relevant, since the dough pieces may differ from one another, in particular as regards weight, size, proofing and shape.

According to a further preferred embodiment, the stamp is arranged along a central axis of the tool extending perpendicular to the support. The stamp is moved substantially perpendicular to the upper side of the dough pieces by means of a stroke movement, and is thus brought into engagement with the dough piece. Arranging the stamp along the central axis of the tool offers the advantage that the stamp can be positioned on the dough piece precisely and easily, and allows pivoting of the tool and/or the stamp in relation to the perpendicularly extending central axis of the tool. In addition, it is advantageous that the stamp can be brought into engagement by means of a horizontal movement and moved substantially horizontally to the upper side of the dough pieces, thus allowing a large number of patterns to be formed with due regard to the different shapes of the dough pieces. In order to further increase the variability of the device, it has been found advantageous to move the stamp also rotationally about the central axis of the tool.

In addition, it will be particularly advantageous when the positioning unit includes a control unit, by means of which the engagement depth and/or the dwell time of the stamp in the dough piece can be controlled. In order to ensure that the quality of the dough products will be consistent and their appearance as identical as possible, it is particularly relevant to take into account the shape, the weight, the consistency and/or the degree of proofing of the dough piece, when controlling the engagement depth and/or the dwell time of the stamp in the dough piece. In this way, not only the undefined position of the dough piece on the support but also further irregularities, which occur during the production of dough pieces depending on the surroundings and the product composition, can be compensated for, when the dough piece is being stamped.

For moving the tool along a lengthwise extension of the support, it will be particularly advantageous when the positioning unit includes a driven handling device. For this purpose, the tool is adapted to be mounted on the handling device, thus allowing the target position of the tool above the dough piece to be approached much more quickly and easily than would be possible in manual operation.

It proved to be particularly advantageous, when the handling device is able to move the tool also in a direction transversely to the lengthwise extension of the support. Also this direction of movement of the handling device serves to position the tool and the stamp on the dough piece in a simple and reliable manner.

For forming complex patterns or for stamping specially shaped dough pieces, in particular dough pieces kneaded into an elongate shape, it is provided according to the present disclosure that the stamp can be pivoted angularly by the handling device and can be positioned above the respective dough piece, depending on the pattern to be formed. The pivoting of the stamp about a perpendicular axis is advantageously controlled by the positioning unit, thus allowing in particular dough pieces kneaded into an elongate shape to be processed independently of their orientation in alignment or on an ideal raster. The problem of the exact positioning of the dough pieces on the support, which is known from the prior art, is overcome insofar.

The structural design of the handling device is here arbitrary. Various known solutions are available to the person skilled in the art for this purpose. This may, for example, be a multi-axis robot or a gantry that can be moved along two axes with an additional pivoting and lifting unit.

In addition, it is additionally advantageous, when, making use of a tool changing device, the tool can be fixed to the handling device in an exchangeable manner. This will enable the operator to easily adapt in each case a production line to different dough products, in particular to dough pieces of different sizes and shapes or different patterns, by simply changing between various tools, which comprise at least one stamp. Moreover, simple and thorough cleaning and maintenance of the components of the tool will be possible by removing the tool, while maximizing the availability of the production line.

In order to limit the components required for realizing the device to a minimum and at the same time increase the productivity, it will be particularly advantageous when a plurality of tools, which are in particular positionable independently of one another, can be fixed to the positioning unit. According to the present disclosure, it will thus be possible to stamp, e.g., in a production line, a plurality of dough pieces simultaneously with the various tools, and this will lead to a significantly increased output.

According to a preferred embodiment, the positioning unit includes an image sensor system with an evaluation unit. The image sensor system may here be of an arbitrary nature, provided that the respective position of the dough piece and thus the deviation from a reference position can be detected. The tool can thus be moved to the correct position relative to the dough piece. The use of an imaging process with, for example, a camera, offers the advantage that the position detection of the dough pieces on the support, as well as the transmission and processing of the data, can be carried out in a very efficient manner. The dough piece can thus be placed on a support in an arbitrary manner, with the device detecting the position of the dough piece automatically and bringing the stamp into engagement with the dough piece at a suitable position.

In order to ensure economical mass production, it will be particularly advantageous, when the support, on which the dough pieces are located, is a conveyor belt. Due to the use of a conveyor belt as a support, handling and/or conveying processes, which are time-consuming on the one hand and cause additional stress on the dough product on the other, can be dispensed with. It follows that, as compared with stamping in pressure cups, it will be particularly advantageous when the positioning unit is able to detect the position of the dough pieces directly on a conveyor belt and the tool is able to approach and stamp the dough pieces.

According to a further preferred embodiment, the conveyor belt can be driven continuously. Stamping in a continuous process leads to a substantial increase in the output quantity in comparison with a clocked operation.

In particular, when the support is a conveyor belt, it proved to be advantageous to synchronize the speed, at which the handling device moves the tool along the lengthwise extension of the conveyor belt, with the speed of the conveyor belt.

According to a further embodiment, the tool has, in addition to the stamp, a downholder which, at the position of engagement of the stamp, can be brought into contact with the dough piece on a side thereof. It will be of advantage when, at the position of rest, the downholder projects beyond the stamp in the direction of the support or the conveyor belt, so that, when a dough piece is approached, it will be the downholder that is first brought into contact with the dough piece, before the stamp is inserted into the dough piece. This serves to fix the position of the stamp on the dough piece on the one hand and to gently retract the stamp from the dough piece back into the position of rest on the other.

The arrangement of the downholder on the tool is basically arbitrary. In order to carry out the stamping at the optimum position on the dough piece and subject the dough piece to the least possible stress during retraction of the stamp, it will be particularly advantageous, when the downholder is arranged in a spring-mounted manner on the lower surface of the tool in spaced relationship with the stamp. This advantageous embodiment allows the stamp to be retracted while the downholder fixes the dough piece on the support until there is no longer any contact between the stamp and the dough piece. This is particularly relevant in the case of a deep engagement depth and/or sticky dough pieces.

Also the shape of the downholder is basically arbitrary. However, in order to be able to optimally transfer the loads occurring at the working position, it will be particularly advantageous when the downholder is annular in shape and surrounds the stamp in a contact-free manner. The force required for fixing the dough piece on the support will thus be evenly distributed and a deformation of the dough piece will be prevented.

The new solution thus opens up the possibility of a method according to the present disclosure used for embossing, imprinting, cutting or stamping a dough piece, making use of a positioning unit and a tool, and making especially use of a device according to respective above-specified embodiments, the method comprising the steps following hereinafter.

The dough pieces are conveyed on a support to a stamping station, the type of support be irrelevant for the time being.

According to the present disclosure, the position of the dough pieces on the support, in particular on a conveyor belt, is detected. The dough pieces may be distributed on the support in an undefined manner. In accordance with the position of the dough pieces on the support, the tool is oriented above the dough piece at a target position over the dough piece. This movement is carried out by the handling device and controlled by the control unit of the positioning unit.

Subsequently, the tool is lowered onto the dough piece until either the downholder, if provided, or the stamp is in contact with the dough piece. In the following step, the stamp is lowered so that the stamp will enter into engagement with the dough piece at the target position determined by the positioning unit. By retracting the stamp from the dough piece, the stamp and the dough piece are released from each other, with the downholder, if provided, supporting the separation of the dough piece and the stamp by fixing the dough piece on the support. According to the present disclosure, the tool is finally lifted off the dough piece and either moved to a position of rest or positioned above another dough piece to be stamped.

Particularly advantageous is the use of an image sensor system, which includes an evaluation unit and which detects the position of the dough pieces on the support and transmits the position of the dough pieces to the control unit of the positioning unit. In the case of an undefined position of the dough pieces, it will thus be possible to move the tool relative to the conveyor belt, independently of the shape of the dough pieces, substantially perpendicular to the surface center of gravity or the geometric center of gravity of the dough piece. In this way, it can be ensured that stamping will always take place in the same way and that, consequently, dough products will be produced which are as identical as possible.

Particularly advantageous is the use of a continuously driven conveyor belt, which allows continuous mass production. In this respect, it will be of advantage to move the tool with the handling device along the conveyor belt in such a way that also the stamping by lowering and lifting the tool can be carried out continuously. For trouble-free operation of the device, it will be advantageous when the downholder fixes the dough piece on the conveyor belt while the stamp is being lifted. In particular in the case of sticky dough products, it may happen that the dough piece is lifted off the conveyor belt while the stamp is being released from the dough piece, and this may cause not only deformations on the dough piece but also malfunctions at the device or the entire production line. The susceptibility to failure can be reduced by providing a downholder.

In the figures following hereinafter, embodiments of a device according to the present disclosure used for stamping a dough piece are sketched.

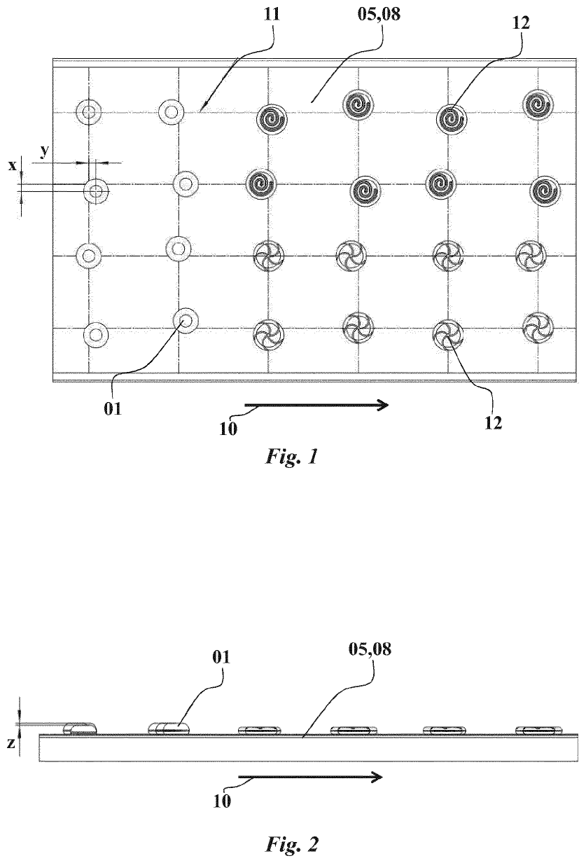

FIG. 1 shows, in a view from above, a first conveyor belt with round dough pieces;

FIG. 2 shows, in a side view, the first conveyor belt with round dough pieces;

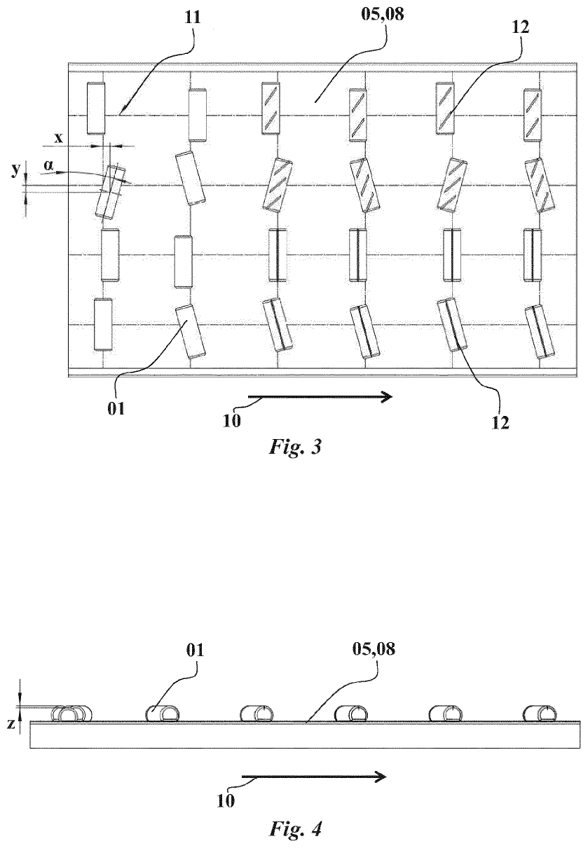

FIG. 3 shows, in a view from above, an alternative conveyor belt with dough pieces kneaded into an elongate shape;

FIG. 4 shows, in a side view, the alternative conveyor belt with dough pieces kneaded into an elongate shape;

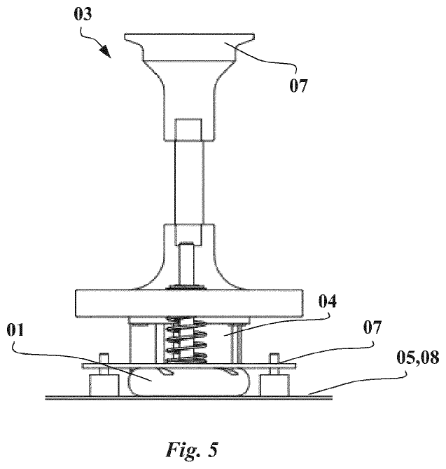

FIG. 5 shows, in a side view, a tool of a device according to the present disclosure; and

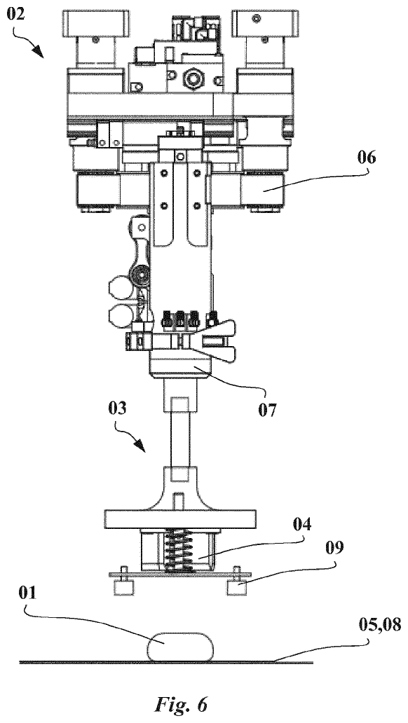

FIG. 6 shows, in a side view, a device according to the present disclosure.

### DETAILED DESCRIPTION

FIG. 1 shows, in a view from above, a support 05 of a device according to the present disclosure for stamping dough pieces 01, wherein the support 05 according to the embodiment shown is a conveyor belt 08 driven along the lengthwise extension in the conveying direction 10. The dough piece 01 can be placed on the support 05 in an arbitrary undefined position. The kneading of the dough pieces from a flat dough sheet is used in particular in continuous mass production and can advantageously take place directly on conveyor belts, whereby further conveying and/or handling processes can be dispensed with. The dough pieces 01 deposited in an arbitrary manner on the support 05 are detected by means of an image sensor system with an evaluation unit, whereby the position deviation x,y of the dough pieces 01 from a reference position in an ideal raster 11 can be determined. This allows the tool 03 to move to a target position on the dough piece 01 and to align the stamping with the center of the round dough piece 01. After stamping, the dough piece 01 has a pattern 12, depending on the respective tool 03 used. As can be seen in FIG. 1, the pattern 12 may comprise, for example, a snail shape (above) or the pattern 12 of a classic Kaiser roll (below).

FIG. 2 shows, in a side view, the conveyor belt 08, which is driven along the lengthwise extension in the conveying direction 10, and the dough pieces 01 according to FIG. 1. It can be seen that the dough pieces 01 exhibit deviations z from a reference height, which, however, can be compensated by the control of the tool 03. The necessary data is transmitted by the image sensor system, which includes the evaluation unit, to the control unit of the positioning unit 02.

FIG. 3 shows a conveyor belt 08 with dough pieces 01 kneaded into an elongate shape, the conveyor belt 08 being driven along the lengthwise extension in the conveying direction 10. In contrast to the previous representation with round dough pieces 01, the position of the dough pieces 01 may not only deviate in two directions x,y from the reference position on the ideal raster 11, but the dough pieces 01 may also be rotationally displaced by an angle α relative to the ideal raster 11. This rotational displacement of the dough pieces 01 kneaded into an elongate shape is detected by the image sensor system including the evaluation unit and the tool 03 is brought into engagement by the positioning unit 02 in the optimum position. This makes it possible to impart an identical pattern 12 to the dough pieces 01 distributed randomly on the support 05. As shown, the pattern 12 may here consist, e.g., of two or three incisions (above) made obliquely in a transverse direction with a sharp stamp 04, as known from baguette rolls, or of one incision (below) extending centrally over the full length, as known from bread rolls. If the incisions are not to extend straight, as shown, but, e.g., in the form of a wave, it is possible to move the stamp 04 horizontally and/or rotationally about the center axis of the tool 03.

FIG. 4 shows a side view of the conveyor belt 08, which is driven along the lengthwise extension in the conveying direction 10, and of the dough pieces 01 kneaded into an elongate shape according to FIG. 3. It can be seen that the dough pieces 01 may have different heights z due to the stress to which they were subjected in the upstream processes and/or the degree of their proofing. In order to be able to ensure a uniform design of the dough pieces 01, it will be necessary that, on the one hand, the image sensor system including the evaluation unit detects not only the position but also the height of the dough pieces 01 and that, on the other hand, the engagement depth and/or the dwell time of the stamp 04 in the dough piece 01 can be regulated by the control unit of the positioning unit 02 depending on the shape, the degree of proofing, the weight and/or the consistency of the dough piece 01.

FIG. 5 shows a sketch of an advantageous embodiment of a tool 03 of the device according to the present disclosure. According to this embodiment, the tool 03 has a downholder 09 that has been brought into contact with the upper side of the dough piece 01. The downholder 09 serves to fix the dough piece 01 on the support 05 and the conveyor belt 08, respectively, when the stamp 04 is withdrawn from the dough piece 01. This will, in particular, be necessary, if the dough piece 01 has an exceptionally tough and/or sticky consistency due to the composition of the dough or due to the degree of proofing. For easily and gently fixing the dough piece 01 on the support 05, the downholder 09 is spring-mounted on the lower surface of the tool 03 in spaced relationship with the stamp 04 and is annular in shape, so to as to distribute the necessary hold-down force as evenly as possible on the dough piece 01. By providing a tool changing device 07, the tool 03 shown can exchangeably be attached to a handling device 06 of the positioning unit 02. The operator will thus be able to easily changeover the production lines for different patterns 12 by simply changing between different tools 03.

FIG. 6 shows a sketch of an embodiment for a device according to the present disclosure. The device consists of a tool 03 and a positioning unit 02, which comprises a handling device 06 and a control unit, not shown, as well as an image sensor system, not shown, with an evaluation unit. By means of the handling device 06, the tool 03 has already been moved to the target position above the dough piece 01, so that in the next step the stamp 04 of the tool 03 can be brought into engagement. For fixing the dough piece 01 on the support 05, the tool 03 includes a spring-mounted downholder 09, which, together with the stamp 04, is brought into contact with the dough piece 01. In the embodiment shown, a round dough piece 01 is intended to be stamped, but, by providing a tool changing device 07, the tool 03 can easily be changed for stamping a dough piece 01 of a different shape or a different pattern 12. In a particularly advantageous embodiment, the support 05 is a continuously driven conveyor belt 08 for use in the mass production of dough products. For this purpose, the tool 03 is moved by the handling device 06 in the conveying direction 10 of the conveyor belt 08, the speed of the conveyor belt 08 and the speed at which the handling device 06 moves the tool 03 being synchronized.

1. A device for embossing, imprinting, cutting or stamping dough pieces, the device comprising:
a positioning unit; and
a tool including a stamp adapted to be brought into engagement with a dough piece;
wherein when
the dough pieces are arranged in an undefined position on a flat support, the positioning unit is operable to detect at least a position of one dough piece, and the tool is adapted to be centered at a target position above the one dough piece.

2. The device according to claim 1,
wherein
the target position is determinable based on surface center of gravity or geometric center of gravity of the one dough piece.

3. The device according to claim 1,
wherein
the stamp is arranged along a central axis of the tool extending perpendicular to the support, wherein, by means of a stroke movement, the stamp is configured to be moved substantially perpendicular to an upper side of the one dough piece and brought into engagement.

4. The device according to claim 1,
wherein
by means of a horizontal movement, the stamp is configured to be brought into engagement and moved substantially horizontally to an upper side of the one dough piece.

5. The device according to claim 1,
wherein
the stamp is configured to be brought into engagement with the one dough piece and moved rotationally about the central axis of the tool.

6. The device according to claim 1,
wherein
the positioning unit includes a control unit, and wherein engagement depth and/or dwell time of the stamp in the one dough piece is controllable depending on shape, weight, consistency and/or degree of proofing of the one dough piece.

7. The device according to claim 1,
wherein
the positioning unit includes a handling device capable of moving the tool along a lengthwise extension of the support.

8. The device according to claim 7,
wherein
the handling device is capable of moving the tool transversely to a lengthwise extension of the support.

9. The device according to claim 7,
wherein
the stamp is pivotable angularly by the handling device.

10. The device according to claim 7,
wherein
making use of a tool changing device, the tool is configured to be fixed to the handling device in an exchangeable manner.

11. The device according to claim 1,
wherein
a plurality of tools, which are positionable independently of one another, is configured to be fixed to the positioning unit.

12. The device according to claim 1,
wherein
the positioning unit includes an image sensor system with an evaluation unit, by which the positioning unit is configured to detect at least the position of the one dough piece on the support.

13. The device according to claim 1,
wherein
the support comprises a conveyor belt on which the dough pieces are conveyable.

14. The device according to claim 13,
wherein
the conveyor belt is configured to be driven continuously.

15. The device according to claim 13,
wherein the positioning unit includes a handling device capable of moving the tool along a lengthwise extension of the support, and wherein
a speed at which the handling device moves the tool along the lengthwise extension of the conveyor belt and a speed of the conveyor belt are configured to be synchronized.

16. The device according to claim 1,
wherein
the tool has a downholder, wherein, at a position of rest, the downholder projects beyond the stamp in a direction of the support and wherein, at a position of engagement of the stamp, the downholder is configured to be brought into contact with the one dough piece on a side thereof.

17. The device according to claim 16,
wherein
the downholder is configured to be arranged in a spring-mounted manner on a lower surface of the tool in spaced relationship with the stamp.

18. The device according to claim 16,
wherein
the downholder is annular in shape and may surround the stamp in a contact-free manner.

19. A method of embossing, imprinting, cutting or stamping a dough piece making use of a positioning unit and a tool, the method comprising:
conveying the dough piece to a stamping station;
detecting a position of the dough piece on a support;
positioning the tool above the dough piece;
moving the tool until a downholder and/or a stamp enter into contact with the dough piece;
bringing the stamp into engagement with the dough piece at a target position;
the forming a pattern into the dough piece;
lifting the stamp until the dough piece and the stamp are released from each other; and
lifting the tool.

20. The method according to claim 19,
wherein
an image sensor system with an evaluation unit detects the position of the dough piece on the support and transmits the position of the dough piece to a control unit of the positioning unit.

21. The method according to claim 19,
wherein the support comprises a conveyor belt, and wherein
simultaneously with the movement of the tool, the tool is displaced with a handling device along the conveyor belt such that a continuous operation of the conveyor belt is possible.

22. The method according to claim 19,
wherein the support comprises a conveyor belt, and wherein
the downholder fixes the dough piece on the conveyor belt while the stamp is being lifted.
